(19) United States
(12) Patent Application Publication
(10) Pub. No.: US 2026/0043979 A1
(43) Pub. Date: Feb. 12, 2026

(54) OPTICAL CABLE AND ACTIVE OPTICAL CABLE

(71) Applicant: AIP Inc., New Taipei City (TW)

(72) Inventor: Chia Lee, New Taipei City (TW)

(21) Appl. No.: 19/262,489

(22) Filed: Jul. 8, 2025

Related U.S. Application Data
(60) Provisional application No. 63/680,677, filed on Aug. 8, 2024.

(51) Int. Cl. G02B 6/44; G02B 6/42

(52) U.S. Cl. CPC G02B 6/4436; G02B 6/4261; G02B 6/443

(57) ABSTRACT

An optical cable and an active optical cable are provided. The optical cable includes a plurality of optical fibers, an outer sheath wrapping the optical fibers, and a functional layer disposed on and extending along an outer surface of the outer sheath. The functional layer has a coefficient of friction less than a coefficient of friction of the outer sheath.

### CROSS REFERENCE TO RELATED APPLICATIONS

This application claims the benefit of U.S. provisional patent application Ser. No. 63/680,677, filed Aug. 8, 2024, the entirety of which is incorporated by reference herein.

### BACKGROUND OF INVENTION

### 1. Field of Invention

The present invention relates to a technical field of optical cables, and particularly to an optical cable with low wind resistance and an active optical cable having the same.

### 2. Related Art

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. OEICs are configured with photonic integrated circuits (PICs) and electronic integrated circuits (EICs) and are generally co-packaged as co-packaged optics (CPO).

Optical cables, generally, are composed of multiple optical fibers bundled in an outer sheath, which can provide high-speed and high-bandwidth optical signal transmission. For example, data centers, such as switch data centers equipped with CPO devices, require a large number of optical cables for high-speed and high-capacity data transmission. Data centers are known to generate high heat during operation. Major improvements in heat dissipation have always been focused on devices (i.e., switches). However, as a main role in the optical signal transmission, there is no effective way to help remove high temperature and heat from data centers through optical cables.

### SUMMARY OF INVENTION

An object of the present application is to provide an optical cable capable of facilitating heat dissipation for data centers.

Another object of the present application is to provide an active optical cable capable of facilitating heat dissipation for an optical transceiver module.

To achieve the above-mentioned objects, the present application provides an optical cable, including a plurality of optical fibers arranged close to each other, an outer sheath wrapping the optical fibers, and a functional layer disposed on and extending along an outer surface of the outer sheath. The functional layer has a coefficient of friction less than a coefficient of friction of the outer sheath.

Optionally, the functional layer is made of a material comprising thermoplastic.

Optionally, the material of the functional layer is further selected from the group consisting of aluminum nitride, graphene, polytetrafluoroethylene, and polydimethylsiloxane.

Optionally, the optical fibers are arranged in a bundle and concentrically disposed within the outer sheath.

Optionally, the outer sheath has a radius, which is determined by the formula as follows:

$$1.2 \times \sqrt{{r}_{f}^{2} \times n} < {r}_{c} < \frac{1.8 \times \sqrt{{r}_{f}^{2} \times n}}{{log}_{2} n / 4 + 0. 5 \times [ ( {log}_{2} n ) - 4 ]} ,$$

in which r_{f} represents a fiber radius, n represents the number of fiber cores and n≥16, and r_{c} represents a radius of the outer sheath.

Optionally, the outer sheath is made of a fire and moisture resistance material.

Optionally, each of the plurality of optical fibers comprises an optical fiber core allowing for light signal transmission, a cladding layer surrounding the optical fiber core and having an index of refraction less than an index of refraction of the optical fiber core, and an outer jacket wrapping the cladding layer.

The present application further provides an active optical cable, including an optical cable, a connecting head connecting with the optical cable, and an optical transceiver module connected to one end of the connecting head opposite to the optical cable. The optical cable includes a plurality of optical fibers, an outer sheath wrapping the optical fibers, and a functional layer disposed on and extending along an outer surface of the outer sheath. The functional layer has a coefficient of friction less than a coefficient of friction of the outer sheath.

The present application provides the optical cable and the active optical cable that use the functional layer having the low coefficient of friction on the outer surface of the optical cable to reduce the wind resistance of the optical cable, thereby facilitating heat dissipation for data centers as well as the optical transceiver module and solving the problem with conventional optical cables that fail to help in heat dissipation.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic cross-sectional structural view of an optical cable in accordance with an embodiment of the present application.

FIG. 2 is a schematic cross-sectional structural view of a single mode optical fiber in accordance with an embodiment of the present application.

FIG. 3 is a schematic cross-sectional structural view of an optical cable in accordance with an embodiment of the present application.

FIG. 4 is a schematic cross-sectional structural view of an optical cable in accordance with an embodiment of the present application.

FIG. 5 is a schematic cross-sectional structural view of an optical cable in accordance with an embodiment of the present application.

FIG. 6 is a schematic structural view of a data process system connected with a plurality of optical cables in accordance with an embodiment of the present application.

FIG. 7 is a schematic structural view of an active optical cable in accordance with an embodiment of the present application.

FIG. 8 is a schematic structural view of the active optical cable of FIG. 7 pluggable to a connecting device.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component, or a first section discussed below could be termed a second element, a second component or a second section without departing from the teachings of the present application.

Unless the context indicates otherwise, terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes.

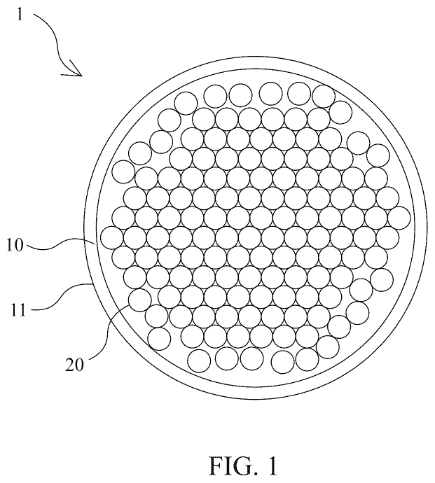

Referring to FIG. 1, FIG. 1 is a schematic cross-sectional structural view of an optical cable in an embodiment of the present application. As shown in FIG. 1, the present application provides an optical cable 1 including an outer sheath 10, a functional layer 11, and a plurality of optical fibers 20. In detail, the plurality of optical fibers 20 are arranged close to each other. Preferably, the optical fibers 20 are arranged in a bundle and concentrically disposed within the outer sheath 10. In some embodiments, the optical fibers 20 may be a stack of optical fiber ribbons.

As shown in FIG. 1, the outer sheath 10 is extruded around the optical fibers 20 and wrap the optical fibers 20. The outer sheath 10 is tubular in shape that surrounds a plurality of optical fiber 20 and servers to protect the optical fiber 20 from fire and moisture. In some embodiments, the outer sheath 10 is made of a fire and moisture resistance material to function as a fire resistant protective layer. The outer sheath 10 is made of a material including, but not limited to, polypropylene (PP), polyvinyl chloride (PVC), polyethylene (PE), etc. Alternatively, the materials of the outer sheath 10 may include magnesium oxide, aluminum oxide. In some embodiments, the outer sheath 10 may be formed into different parts with different materials or sizes. Each part of the outer sheath 10 has its own characteristics (i.e., different fire resistance capabilities) for suitable scenarios. For example, a front part of the outer sheath 10 located close to an area of a data center (not shown) having high temperatures may be slightly larger in thickness than a rear part of the outer sheath 10 away from the data center in order to have relatively great fire resistance performance.

Referring to FIG. 1, the functional layer 11 is disposed on and extends along an outer surface of the outer sheath 10. Specifically, the functional layer 11 is coated on the outer sheath 10 and is a relatively thin, continuous and contiguous film layer (e.g., contiguous circumferentially and longitudinally for a longitudinal length along the length of the optical cable 1) wrapping the outer surface of the outer sheath 10. In detail, the functional layer 11 is smooth and has a coefficient of friction less than a coefficient of friction of the outer sheath 10. With the low coefficient of friction, the functional layer 11 can significantly reduce the wind resistance of the optical cable 1.

In some embodiments, the functional layer 11 is made of a material including thermoplastic. Specifically, the material of the functional layer 11 is selected from the group consisting of aluminum nitride, graphene, polytetrafluoroethylene, and polydimethylsiloxane. The functional layer 11 is provided to reduce the wind resistance of the air exhausted by a fan device (not shown) in the data center. Specifically, the functional layer 11 is a polymer coating layer formed by depositing thermoplastic materials on the surface of the outer sheath 10. According to different deposition methods, polymer coating processes can be divided into physical vapor deposition (PVD), chemical vapor deposition (CVD), electroplating, solution deposition, and spraying that are not limited thereto.

Specifically, polymer materials are excellent in corrosion resistance and mechanical properties, lightweight, and have great processability. In some embodiments, metal or ceramic powder can be added to the polymer material to form a polymer thermally conductive composite material. In some embodiments, additives with high thermal conductivity may be added to polymer materials to improve their thermal conductivity. The high thermal conductivity additive may include boron nitride, silicon carbide, aluminum nitride, and aluminum oxide, but is not limited thereto.

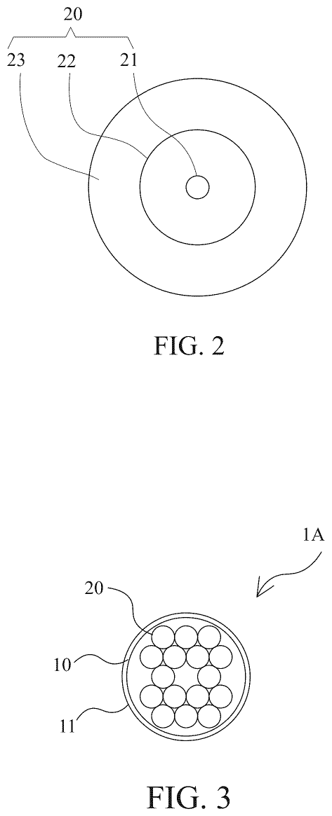

Referring to FIG. 2, which is a schematic cross-sectional structural view of a single mode optical fiber in accordance with an embodiment of the present application, each of the optical fibers 20 is substantially composed of an optical fiber core 21 allowing for light signal transmission, a cladding layer 22 surrounding the optical fiber core 21 and having an index of refraction less than an index of refraction of the optical fiber core 21, and an outer jacket 23 wrapping the cladding layer 22. In some embodiments, a reinforcement layer (not shown) may be provided between the cladding layer 22 and the outer jacket 23 to enhance structural strength of the optical fiber 20. The optical fibers 20 surrounded by the outer sheath 10 may be, for example, a single-mode fiber 1, multi-mode fibers, or polarization-maintaining fibers, which are not limited in the present application.

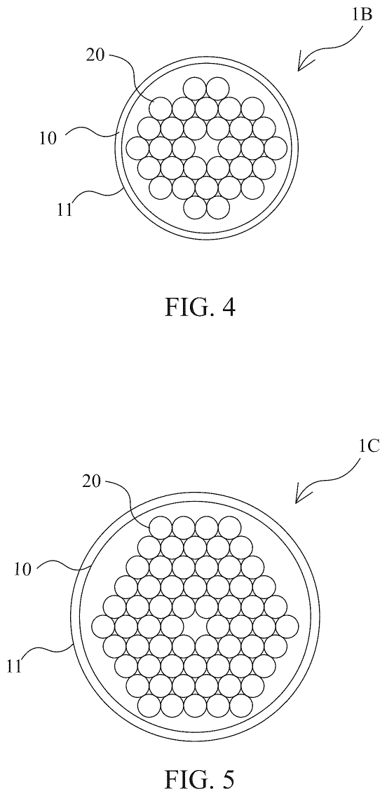

Referring to FIGS. 3 to 5, FIGS. 3 to 5 are schematic cross-sectional structural views of an optical cable in different embodiments of the present application. As shown in FIG. 3, an optical cable 1A including an outer sheath 10 with the outer diameter of 1.75 millimeters (mm) can contain and house 16 optical fibers 20. As shown in FIG. 4, an optical cable 1B including an outer sheath 10 with the outer diameter of 2.25 mm can contain and house 32 optical fibers 20. As shown in FIG. 5, an optical cable 1C including an outer sheath 10 with the outer diameter of 2.9 mm can contain and house 64 optical fibers. In some embodiments, each optical fiber core 21 may convey optical signals independently, so that the multicore optical fiber may function as multiple individual optical fibers and transmit optical signals to applied devices.

In this embodiment, a radius r_{c} of the outer sheath 10 is determined according to the formula as follows:

$$1.2 \times \sqrt{{r}_{f}^{2} \times n} < {r}_{c} < \frac{1.8 \times \sqrt{{r}_{f}^{2} \times n}}{{log}_{2} n / 4 + 0. 5 \times [ ( {log}_{2} n ) - 4 ]}$$

In this formula, r_{f} represents the fiber radius, n represents the number of the optical fiber cores 20 and n≥16. With the radius of the outer sheath 10 calculated based on this formula, the internal space formed by the outer sheath 10 can be effectively configured and maximally used for accommodating the fiber cores. The fiber radius of this formula is, for example, 0.125 mm. In some embodiments, the number of fiber cores n are 16 and the radius r_{c} of the outer sheath 10 is 0.875 mm. In some embodiments, the number of fiber cores n are 32 and the radius r_{c} of the outer sheath 10 is 1.125 mm. In some embodiments, the number of fiber cores n are 64 and the radius r_{c} of the outer sheath 10 is 1.45 mm. In some embodiments, the number of fiber cores n are 128 and the radius r_{c} of the outer sheath 10 is 1.9 mm.

In some embodiments, an optical fiber connector with a ferrule (not shown) is used to connect two ends of the optical cable. The optical fiber connector allows for quick connection or disconnection of optical fiber cables without splicing. The optic fiber connector usually features a ferrule that helps keep the optical fibers in place and align strands of the optical fibers to pass the light.

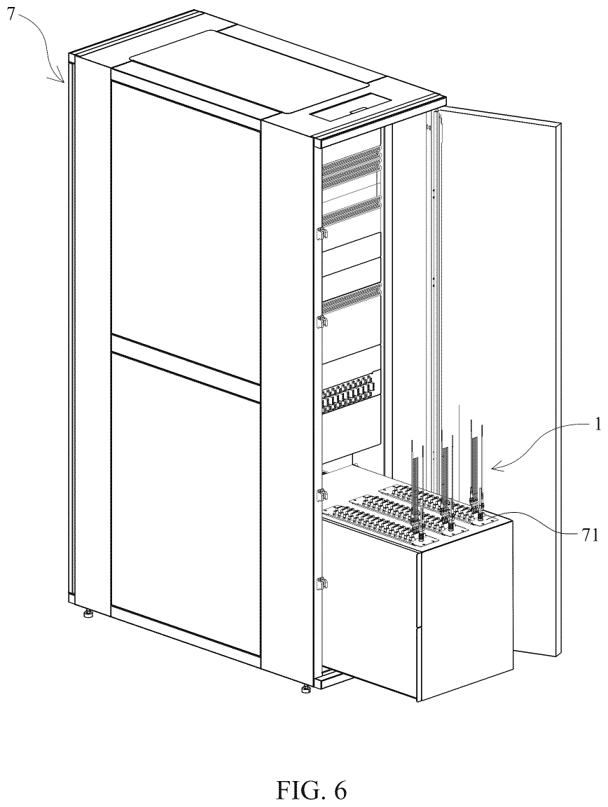

Referring to FIG. 6, FIG. 6 is a schematic structural view of a data process system 7 connected with a plurality of the optical cables 1 in an embodiment of the present application. The plurality of the optical cables 1 are connected to a connecting device 71 of the data process system 7 for high-speed signal transmission, and the heat generated by components in the data process system 7 is blown out by a fan device (not shown) installed in the data process system 7 more effectively due to the low coefficient of friction of the functional layer 11 and the low wind resistance of the optical cable 1.

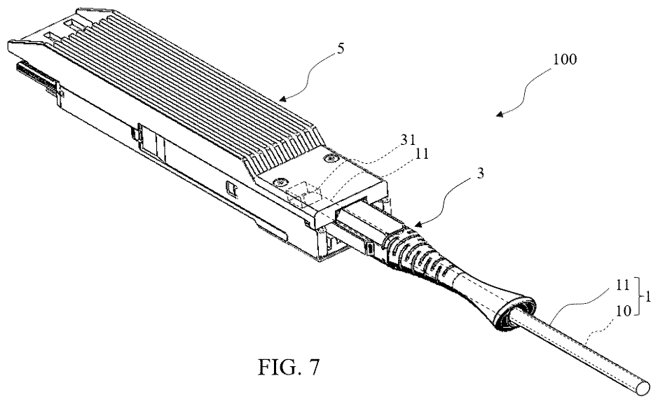

The present application further provides an active optical cable. Referring to FIG. 7, which is a schematic structural view of an active optical cable 100 in accordance with an embodiment of the present application. The active optical cable 100 includes an optical cable 1, a connecting head 3, and an optical transceiver module 5. Specifically, the optical transceiver module 5 includes an optoelectronic integrated circuit (not shown) and a waveguide device (not shown) installed in the optical transceiver module 5 that are configured for electro-optical signal and optoelectronic signal transmission. As shown in FIG. 7, the optical cable 1 used in the active optical cable 100 also includes an outer sheath 10 and a functional layer 11 wrapping the outer sheath 10. It should be noted that the structure of the optical cable 1 of the active optical cable 100 is the same as the optical cable 1 described in the above-mentioned embodiments, so its detailed structure will not be repeated here.

As shown in FIG. 7, the connecting head 3 connects with the optical cable 1 at one end of the optical cable 1. Specifically, the connecting head 3 includes a contact portion 31 configured in such a way that the functional layer 11 of the optical cable 1 is disposed in contact with the contact portion 31. In detail, the contact portion 31 is configured to contact a circuit board (not shown) supporting the optoelectronic integrated circuit and the waveguide device inside the optical transceiver module 5. With the physical contact between the contact portion 31 and the functional layer 11 and between the contact portion 31 and the circuit board of the optical transceiver module 5, the heat generated by the optoelectronic and electrical components (not shown) on the circuit board can be conducted through the functional layer 11 out of the optical transceiver module 5.

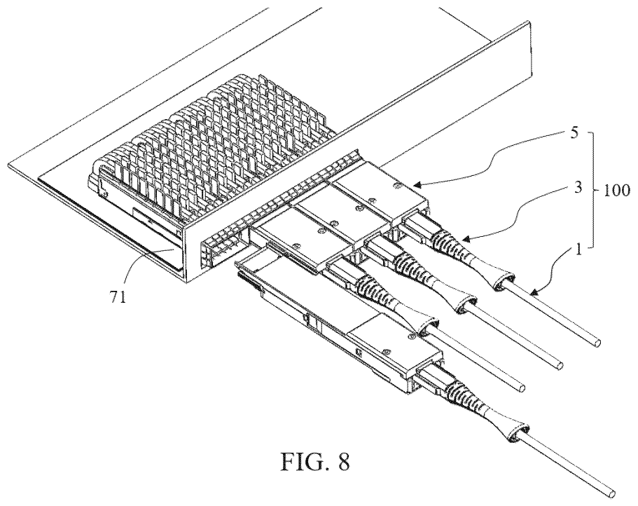

Referring to FIG. 8, which is a schematic structural view of the active optical cable 100 of FIG. 7 pluggable to the connecting device 71, in this embodiment, the optical transceiver module 5 is configured to detachably connect to the connecting device 71 installed in the data process system 7 as shown in FIG. 6. As stated above, the heat generated by components in the data process system 7 is discharged by the fan device (not shown) more effectively due to the low coefficient of friction of the functional layer 11 of the active optical cable 100.

Accordingly, the present application provides the optical cable and the active optical cable that use the functional layer having the low coefficient of friction on the outer surface of the optical cable to reduce the wind resistance of the optical cable, thereby facilitating heat dissipation for data centers as well as the optical transceiver module and solving the problem with conventional optical cables that fail to help in heat dissipation.

Although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. An optical cable, comprising:
a plurality of optical fibers arranged close to each other;
an outer sheath wrapping the optical fibers; and
a functional layer disposed on and extending along an outer surface of the outer sheath, wherein the functional layer has a coefficient of friction less than a coefficient of friction of the outer sheath.

2. The optical cable of claim 1, wherein the functional layer is made of a material comprising thermoplastic.

3. The optical cable of claim 2, wherein the material of the functional layer is further selected from the group consisting of aluminum nitride, graphene, polytetrafluoroethylene, and polydimethylsiloxane.

4. The optical cable of claim 1, wherein the optical fibers are arranged in a bundle and concentrically disposed within the outer sheath.

5. The optical cable of claim 1, wherein the outer sheath has a radius, which is determined by the formula as follows:
$$1.2 \times \sqrt{{r}_{f}^{2} \times n} < {r}_{c} < \frac{1.8 \times \sqrt{{r}_{f}^{2} \times n}}{{log}_{2} n / 4 + 0. 5 \times [ ( {log}_{2} n ) - 4 ]}$$
wherein r_{f} represents a fiber radius, n represents the number of fiber cores and n≥16.

6. The optical cable of claim 1, wherein the outer sheath is made of a fire and moisture resistance material.

7. The optical cable of claim 1, wherein each of the plurality of optical fibers comprises an optical fiber core allowing for light signal transmission, a cladding layer surrounding the optical fiber core and having an index of refraction less than an index of refraction of the optical fiber core, and an outer jacket wrapping the cladding layer.

8. An active optical cable, comprising:
an optical cable comprising:
a plurality of optical fibers;
an outer sheath wrapping the optical fibers; and
a functional layer disposed on and extending along an outer surface of the outer sheath, wherein the functional layer has a coefficient of friction less than a coefficient of friction of the outer sheath; and
a connecting head connecting with the optical cable; and
an optical transceiver module connected to one end of the connecting head opposite to the optical cable.

9. The active optical cable of claim 8, wherein the functional layer is made of a material comprising thermoplastic.

10. The active optical cable of claim 9, wherein the material of the functional layer is further selected from the group consisting of aluminum nitride, graphene, polytetrafluoroethylene, and polydimethylsiloxane.

11. The active optical cable of claim 8, wherein the outer sheath has a radius, which is determined by the formula as follows:
$$1.2 \times \sqrt{{r}_{f}^{2} \times n} < {r}_{c} < \frac{1.8 \times \sqrt{{r}_{f}^{2} \times n}}{{log}_{2} n / 4 + 0. 5 \times [ ( {log}_{2} n ) - 4 ]}$$
wherein r_{f} represents a fiber radius, n represents the number of fiber cores and n≥16, and r_{c} represents a radius of the outer sheath.

12. The active optical cable of claim 8, wherein the connecting head is detachably connected to the optical transceiver module and comprises a contact portion, the functional layer of the optical cable is disposed in contact with the contact portion.
